(19) United States
(12) Patent Application Publication
(10) Pub. No.: US 2020/0344085 A1
(43) Pub. Date: Oct. 29, 2020

(54) CONTROL DEVICE, SERVER, INFORMATION PRESENTATION SYSTEM, CONTROL PROGRAM, AND CONTROL METHOD

(71) Applicant: SHARP KABUSHIKI KAISHA, Sakai City (JP)

(72) Inventors: IICHIRO FUKUI, Sakai City (JP); TAKUYA OYAIZU, Sakai City (JP); TADAO ANDOH, Sakai City (JP)

(21) Appl. No.: 16/807,992

(22) Filed: Mar. 3, 2020

(30) Foreign Application Priority Data
Apr. 25, 2019 (JP) 2019-084293

(51) Int. Cl. H04L 12/28

(52) U.S. Cl. CPC H04L 12/2814; H04L 12/2829; H04L 12/2825

(57) ABSTRACT

Provided is a control device configured to control an information presentation system constituted of a plurality of electronic apparatuses and a server. The control device includes a presentation generation unit configured to receive holding information of the electronic apparatuses and generate presentation information to be presented to a user, and an apparatus selection unit configured to select the electronic apparatus in charge of performing presentation of the presentation information.

### CROSS-REFERENCE TO RELATED APPLICATIONS

This application claims the benefit of priority to Japanese Patent Application Number 2019-084293 filed on Apr. 25, 2019. The entire contents of the above-identified application are hereby incorporated by reference.

### BACKGROUND

### Technical Field

The disclosure relates to a control device, a server, an information presentation system, a control program, and a control method.

Research and development of technology have been carried out in which a home appliance having a communication function uploads, to a server, information held by the home appliance such as information indicating operations and information indicating states of the appliance, thereby causing an information processing terminal working with the server to present the information to be presented to a user.

For example, JP 2004-185612 A discloses an operation history usage system in which a terminal home appliance, a server home appliance, and an application server are configured to be connected to one another through a network. In this system, the terminal home appliance is equipped with a device agent configured to compile sets of information including appliances operated by a user, operation contents thereof and the like, and record them as operation histories. The server home appliance is equipped with a user agent configured to accept the operation histories from the device agent and perform centralized management thereof.

### SUMMARY

However, in the operation history usage system of JP 2004-185612 A, in a case where a user has a plurality of information processing terminals in operation, all of these information processing terminals present the same information to the user, thereby causing the user to receive the duplicate information over and over again in some case. This raises a problem that it is difficult for the user to obtain necessary information from among many pieces of information including the duplicate information.

An aspect of the disclosure has been conceived in view of the above-mentioned problem, and an object of the disclosure is to suppress the duplication of the information presented to a user when the user has a plurality of information processing terminals, by selecting the formation processing terminal in charge of presenting the information.

In order to solve the above-mentioned problem, a control device according to an aspect of the disclosure is a control device configured to control an information presentation system constituted of a plurality of electronic apparatuses each having a communication function and a server capable of performing transmission and/or reception with at least one of the plurality of electronic apparatuses. The stated control device includes: a presentation generation unit configured to execute presentation generation processing in which, from at least one of the plurality of electronic apparatuses, holding information held the at least one of the plurality of electronic apparatuses is received, and presentation information to be presented to a user of the plurality of electronic apparatuses is generated from contents of the holding information that is received; and an apparatus selection unit configured to execute apparatus selection processing in which an electronic apparatus of the plurality of electronic apparatuses in charge of performing presentation of the presentation information is selected in accordance with information presentation forms of the plurality of electronic apparatuses.

In order to solve the above problem, a server according to an aspect of the disclosure is a server configured to communicate with a plurality of electronic apparatuses to constitute an information presentation system and included in the plurality of electronic apparatuses. The server includes at least one control device, and the at least one control device executes presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received, and also executes apparatus selection processing in which an electronic apparatus of the plurality of electronic apparatuses in charge of performing presentation of the presentation information is selected in accordance with information presentation forms of the plurality of electronic apparatuses.

In order to solve the above problem, an information presentation system according to an aspect of the disclosure is an information presentation system constituted of a plurality of electronic apparatuses each having a communication function and a server capable of performing transmission and/or reception with at least one of the plurality of electronic apparatuses, and controlled by at least one control device. The at least one control device executes presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received, and also executes apparatus selection processing in which an electronic apparatus of the plurality of electronic apparatuses in charge of performing presentation of the presentation information is selected in accordance with information presentation forms of the plurality of electronic apparatuses.

In order to solve the above problem, a control method according to an aspect of the disclosure is a control method for a control device configured to control an information presentation system constituted of a plurality of electronic apparatuses each having a communication function and a server capable of performing transmission and/or reception with at least one of the plurality of electronic apparatuses. The control method includes executing presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received; and executing apparatus selection processing in which an electronic apparatus of the plurality of electronic apparatuses in charge of performing presentation of the presentation information is selected in accordance with information presentation forms of the plurality of electronic apparatuses.

According to aspects of the disclosure, it is possible to suppress a situation where the information presented by the information presentation system to the user is duplicated.

### BRIEF DESCRIPTION OF DRAWINGS

The disclosure will be described with reference to the accompanying drawings, wherein like numbers reference like elements.

FIG. 1 is a schematic diagram illustrating an overview of an information presentation system according to an embodiment of the disclosure.

FIG. 2 is a block diagram illustrating a functional configuration of an information presentation system according to an embodiment of the disclosure.

FIG. 3 is a flowchart illustrating a presentation method for presentation information according to an embodiment of the disclosure.

FIG. 4 is a flowchart illustrating a presentation method for presentation information according to a modification of the disclosure.

### DESCRIPTION OF EMBODIMENTS

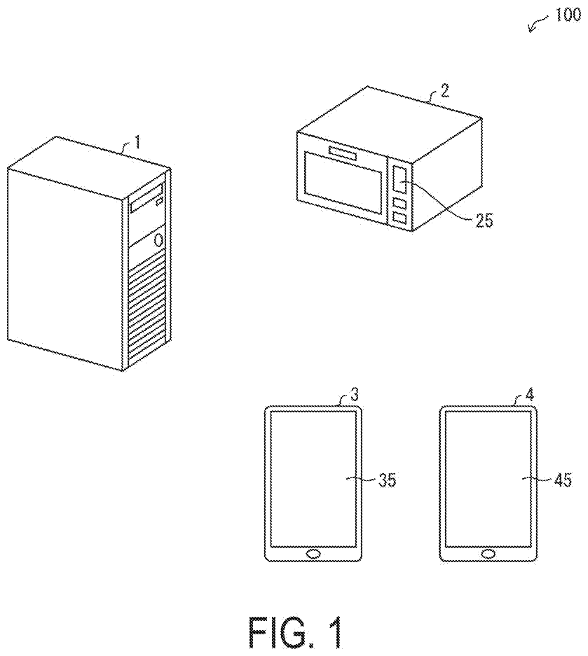

An embodiment of the disclosure will be described in detail with reference to FIGS. 1 to 4. Hereinafter, as an information presentation system according to an embodiment of the disclosure, an information presentation system constituted of one server and three electronic apparatuses will be cited and described, where one of the electronic apparatuses is a home appliance and two of them are communication devices.

Note that the server constituting the information presentation system according to an aspect of the disclosure may be a single server or a plurality of servers. The electronic apparatuses constituting the information presentation system according to an aspect of the disclosure may be three or more electronic apparatuses. Each of the numbers of home appliances and communication devices included in the electronic apparatuses may be one, or two or more. Furthermore, in the information presentation system according to an aspect of the disclosure, any of the plurality of electronic apparatuses is owned by the same user.

### Overview of Information Presentation System

As illustrated in FIG. 1, an information presentation system 100 according to an embodiment of the disclosure is constituted of a server 1, a home appliance (electronic apparatus) 2, a first communication apparatus (electronic apparatus) 3, and a second communication apparatus (electronic apparatus) 4. The home appliance 2, the first communication apparatus 3, and the second communication apparatus 4 are electronic apparatuses having achieved user registrations, which will be explained later, by the same user (not illustrated). In this specification, the home appliance 2, the first communication apparatus 3, and the second communication apparatus 4 may be referred to as “registered electronic apparatuses”. The information presentation system 100 is a system where presentation information, which will be described later, is presented to a user of the registered electronic apparatuses.

The server 1 communicates with the home appliance 2, the first communication apparatus 3, and the second communication apparatus 4 to transmit/receive various kinds of information, and stores and manages the received information.

The home appliance 2 has a communication function, and is, for example, a microwave oven, an air conditioner (hereinafter, also referred to as “air-con”), or a refrigerator. In the present embodiment, the home appliance 2 is considered to be a microwave oven. The first communication apparatus 3 and the second communication apparatus 4 are, for example, smart-phones or tablet terminals, and communicate with the server 1. In the present embodiment, the first communication apparatus 3 and the second communication apparatus 4 are considered to be smart-phones.

The home appliance 2 includes a display unit configured to display various images. Likewise, the first communication apparatus 3 and the second communication apparatus 4 also include display units. The display unit of the home appliance 2 is an example of a second presentation device 25 to be described later, the display unit of the first communication apparatus 3 is an example of a third presentation device 35 to be described later, and the display unit of the second communication apparatus 4 is an example of a third presentation device 45 to be described later.

As described above, the information presentation system 100 is constituted of the plurality of registered electronic apparatuses each having a communication function and the server 1 able to transmit/receive information to/from at least one of the plurality of registered electronic apparatuses.

When there exists presentation information about any of the registered electronic apparatuses to be presented to a user, the information presentation system 100 selects the registered electronic apparatus in charge of presenting the above presentation information so that the presentation information is presented to the user by the selected registered electronic apparatus. In the following description, the selected registered electronic apparatus is referred to as selected electronic apparatus.

### Functional Configuration of Server, Home Appliance, First Communication Apparatus, and Second Communication Apparatus

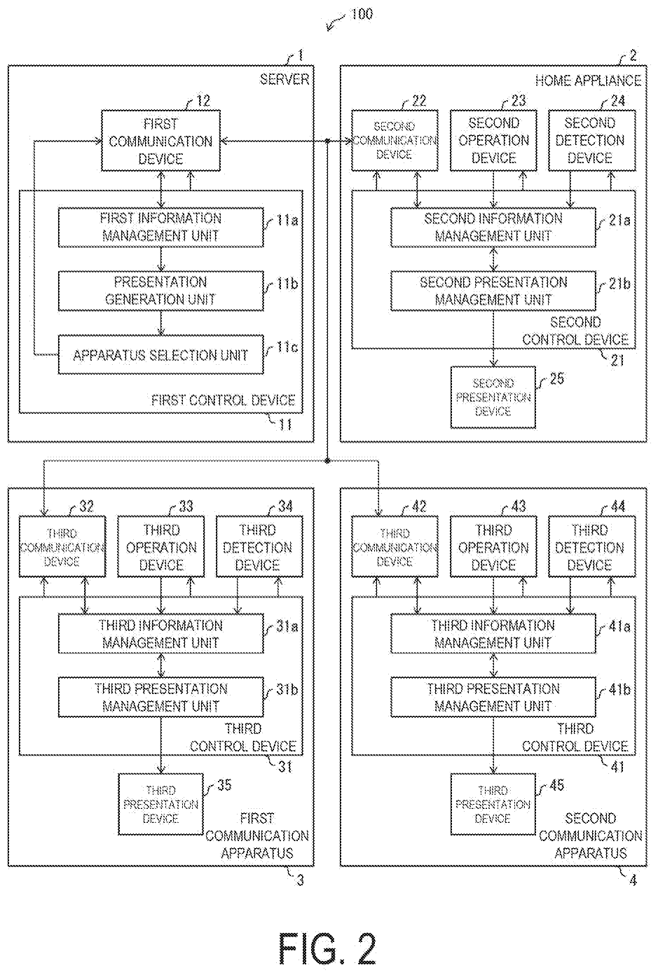

Next, a functional configuration of each of the server 1, the home appliance 2, the first communication apparatus 3, and the second communication apparatus 4 will be described with reference to FIG. 2. As illustrated in FIG. 2, the server 1 includes at least one first control device II and a first communication device 12. The first communication device 12 communicates with at least one of a second communication device 22 to be described later and third communication devices 32 and 42 to be described later, via an antenna (not illustrated).

The first control device 11 is, for example, a CPU, and comprehensively controls devices and units mounted in the server 1. This applies also to a second control device 21 to be described later and third control devices 31 and 41 to be described later. The first control device 11 includes a first information management unit 11a, a presentation generation unit 11b, and an apparatus selection unit 11c. Details of the first information management unit 11a, the presentation generation unit 11b, and the apparatus selection unit 11c will be described later.

As illustrated in FIG. 2, the home appliance 2 includes the second control device 21, the second communication device 22, a second operation device 23, a second detection device 24, and the second presentation device 25. The second control device 21 includes a second information management unit 21a and a second presentation management unit 21b. Details of the second information management unit 21a and the second presentation management unit 21b will be described later.

The second communication device 22 communicates with the first communication device 12 via an antenna (not illustrated). The second communication device 22 may communicate with the third communication devices 32 and 42 to be described later.

The second operation device 23 accepts operation input of the home appliance The second detection device 24 is a pressure sensor (hereinafter, referred to as a “door open/close sensor”) configured to detect an open/close state of a door included in the home appliance 2 in the present embodiment. The second presentation device 25 is a display unit of the home appliance 2 in the present embodiment. When the home appliance 2 corresponds to a selected electronic apparatus, the second presentation device 25 displays, on the display unit, presentation information received from the presentation generation unit 11b of the server 1 via the second communication device 22, thereby presenting the presentation information to the user.

As illustrated in FIG. 2, the first communication apparatus 3 includes the third control device 31, the third communication device 32, a third operation device 33, a third detection device 34, and the third presentation device 35. The third control device 31 includes a third information management unit 31a and a third presentation management unit 31b. Details of the third information management unit 31a and the third presentation management unit 31b will be described later.

The third communication device 32 communicates with the first communication device 12 via an antenna (not illustrated). The third communication device 32 may communicate with the second communication device 22 and the third communication devices 42 to be described later.

The third operation device 33 accepts operation input of the first communication apparatus 3. The third detection device 34 is an acceleration sensor configured to detect movement of the first communication apparatus 3. The third detection device 34 detects a three-dimensional movement of the first communication apparatus 3, such as the movement of the first communication apparatus 3 when it is lifted.

The third presentation device 35 is a display unit of the first communication apparatus 3 in the present embodiment. When the first communication apparatus 3 corresponds to a selected electronic apparatus, the third presentation device 35 displays, on the display unit, presentation information received from the presentation generation unit 11b of the server 1 via the third communication device 32, thereby presenting the presentation information to the user.

As illustrated in FIG. 2, the second communication apparatus 4 includes the third control device 41, the third communication device 42, a third operation device 43, a third detection device 44, and the third presentation device 45. The configuration and processing contents of the third control device 41, third communication device 42, third operation device 43, third detection device 44, and third presentation device 45 are similar to those of the third control device 31, third communication device 32, third operation device 33, third detection device 34, and third presentation device 35 of the first communication apparatus 3.

The second detection device 24 included in the home appliance 2 is not limited to the door open/close sensor, and may be, for example, a temperature sensor configured to detect a temperature inside the heating chamber, or may be any other sensor. The third detection device 34 included in the first communication apparatus 3 may also be any sensor other than the acceleration sensor. Furthermore, these registered electronic apparatuses may not include the second detection device 24 or the third detection devices 34 and 44.

The presentation device included in each registered electronic apparatus is not limited to the display unit, and may be, for example, a light emitting diode (LED) that presents the presentation information by variations in lighting mode of light, or a speaker that presents the presentation information by voice. The registered electronic apparatus may include a plurality of presentation devices, and the plurality of presentation devices may operate in a complex manner to present the presentation information to the user.

### First Control Device

The first information management unit 11a is a ROM, a RAM or the like, and serves as a database configured to store and manage various kinds of information of the registered electronic apparatuses included in the information presentation system 100. The first information management unit 11a transmits/receives various kinds of information to/from at least one of the second information management unit 21a to be described later and the third information management units 3ia and 41a to be described later, via the first communication device 12.

The first control device 11 receives holding information that the respective registered electronic apparatuses hold by the second information management unit 21a to be described later and the third information management units 31a and 41a to be described later. The holding information may contain, for example, at least one of running information indicating a running state of the registered electronic apparatus, storage information such as setting information stored in advance in the second information management unit 21a to be described later and the third information management units 31a and 41a to be described later in the registered electronic apparatuses, and detection information detected by the detection device when the registered electronic apparatus includes the detection device exemplified by the second detection device 24. The holding information is not limited thereto, and may be any information held by the registered electronic apparatuses.

According to the above configuration, the server 1 is able to receive, store, and manage a variety of information held by the registered electronic apparatuses. Accordingly, it is possible for the server 1 to select a registered electronic apparatus able to more reliably present the presentation information to a user, as a selected electronic apparatus, in apparatus selection processing to be described later.

Various kinds of information stored and managed by the first information management unit 11a may include, in addition to the above-mentioned holding information, user registration information of each registered electronic apparatus, for example. The user registration information is information indicating which. user has achieved the user registration for each of the registered electronic apparatuses. A specific method for the user registration will be described later.

The first control device 11 periodically receives the holding information at a predetermined time interval. The predetermined time may be any time. The registered electronic apparatus may transmit holding information to the server 1 separately from the above periodic reception, and the first control device 11 may receive this holding information. It is preferable that the transmission of the holding information be carried out by the registered electronic apparatus at a time of the state of the registered electronic apparatus being changed such as when the registered electronic apparatus has detected an operation. However, the disclosure is not limited thereto, and the transmission thereof may be carried out at any timing.

When it is determined that information to be presented to a user is contained in the holding information received from each of the registered electronic apparatuses, the presentation generation unit 11b executes presentation generation processing in which presentation information to be presented to the user of the registered electronic apparatus is generated from the contents of the received holding information.

The “information to be presented to the user” contained in the holding information includes, for example, information indicating that a power supply of the registered electronic apparatus is turned on or off, information indicating a failure of the registered electronic apparatus, and information indicating that the registered electronic apparatus has detected an abnormal detection result by the detection device. However, the disclosure is not limited thereto, and the presentation generation unit 11b may determine that any information contained in the holding information is “information to be presented to the user”.

When the presentation generation unit 11b has completed the generation of the presentation information, the apparatus selection unit 11c executes apparatus selection processing in which the apparatus in charge of presenting the presentation information is selected from among the home appliance 2, the first communication apparatus 3, and the second communication apparatus 4. In the apparatus selection processing, the apparatus selection unit 11c uses information related to information presentation forms by the home appliance 2, the first communication apparatus 3, and the second communication apparatus 4 for the above-discussed selection. In other words, the apparatus selection unit 11c executes the apparatus selection processing of selecting the registered electronic apparatus in charge of presenting the presentation information in accordance with the information presentation forms of the plurality of registered electronic apparatuses.

The information presentation forms are divided into a highly reliable form in which the presentation information is expected to be recognized with certainty by the user, and a not-highly reliable form in which the presentation information is presented regardless of whether the presentation information is recognized by the user with certainty. The highly reliable form includes, for example, a form in which the presentation information is presented when the door of the home appliance 2 is opened. Whether the door of the home appliance 2 is opened is determined based on the door open/close information, which is detection information of the second detection device 24, contained in the holding information of the home appliance 2.

In this case, the probability that the door of the home appliance 2 has been opened by a user as the owner of the home appliance 2 is high. In the case where presentation information is presented on the second presentation device 25 at the time of the user having opened the door of the home appliance 2, it can be thought of that the user is able to recognize the presentation information with a high probability.

As another example of a highly reliable form, the following can be cited: when an operation from the second operation device 23 or the third operation devices 33 and 43 is received, a form of presenting the presentation information by the registered electronic apparatus from which the operation has been accepted; when a television set is included in the registered electronic appliance, a form of presenting the presentation information at the start of watching television; and when the first communication apparatus 3 is provided with a voice interaction function, a form of presenting the presentation information during the voice interaction between the first communication apparatus 3 and the user. However, the disclosure is not limited thereto.

On the other hand, a not-highly reliable form is a form in which the home appliance 2 presents the presentation information on the second presentation device 25 regardless of the user's operation, for example. As an example, a form may be cited in which, during the automatic maintenance of the home appliance 2 that is carried out automatically regardless of the user's operation, an image or the like indicating that the home appliance 2 is in a state of automatic maintenance is presented on the second presentation device 25. In this case, since the user does not always pay attention to the home appliance 2, the probability of the user recognizing the presentation of the presentation information by the second presentation device 25 is unlikely to be high. Another not-highly reliable form may be a form of presenting various kinds of presentation information in which the user's operation does not serve as a trigger.

One registered electronic apparatus may have both a highly reliable form and a not-highly reliable form as the forms of information presentation. For example, a form in which the presentation information is presented during voice interaction is a highly reliable form when the first communication apparatus 3 is provided with, in addition to the voice iteration function, a function of receiving a change in the state of the home appliance 2 at any time in cooperation with the home appliance 2, while a form in which a change in the state of the home appliance 2 is presented every the change in the state thereof is received is not-highly reliable form. This is because the receiving of a change in the state of the home appliance 2 is carried out at any time regardless of the user's operation.

It is preferable that the above-discussed information presentation form of each of the registered electronic apparatuses included in the information presentation system 100 be such that the presentation information is received in advance by the server 1 as the holding information of each of the registered electronic apparatuses, and stored and managed by the server 1. The apparatus selection unit 11c, when selecting a selected electronic apparatus, preferentially selects the registered electronic apparatus able to present the presentation information by a highly reliable presentation form for the information presentation system 100. In the case where the selected electronic apparatus is provided with both a highly reliable form and not-highly reliable form as the forms of information presentation, the apparatus selection unit 11c may select only the highly reliable form provided to the selected electronic apparatus as the form of presenting the presentation information.

Specifically, when the apparatus selection unit 11c has received presentation preparation information indicating that a prescribed condition for reliably presenting the presentation information to a user is satisfied from any of the registered electronic apparatuses, the apparatus selection unit 11c selects the registered electronic apparatus having transmitted the presentation preparation information as a selected electronic apparatus. For example, when the second detection device 24 detects an operation of opening the door of the home appliance 2, the home appliance 2 determines that the prescribed condition is satisfied and then transmits presentation preparation information to the server 1. Then, the apparatus selection unit 11c, after receiving the presentation preparation information, selects the home appliance 2 having transmitted the presentation preparation information as a selected electronic apparatus.

The prescribed condition is not limited thereto, and may be a condition indicating that the registered electronic apparatus is in a state able to present the presentation information by a highly reliable form.

The registered electronic apparatus, when having presented the presentation information, transmits presentation completion information indicating that the presentation has been carried out, to the server 1. When the apparatus selection unit 11c has received the presentation completion information, the apparatus selection processing is stopped. In this case, since the apparatus selection unit 11c does not select the selected electronic apparatus, the presentation information is also not presented by the selected electronic apparatus. With the above configuration, it is possible for the apparatus selection unit 11c to suppress a situation in which the duplicate presentation information is presented to the user.

As described above, according to the configuration in which the first control device 11 selects which of the registered electronic apparatuses should be in charge of presenting the presentation information, the information presentation system 100 is able to suppress a situation in which the user is redundantly presented with the same presentation information from the plurality of registered electronic apparatuses owned by the user. Thus, the user is not presented with unnecessary duplicate information, which eliminates troublesome work to find necessary information from among a large amount of information including the duplicate information.

Further, according to the configuration in which the registered electronic apparatus that satisfies the prescribed condition is selected as a selected electronic apparatus, the information presentation system 100 is reliably able to make the user recognize the presentation information. Accordingly, the information presentation system 100 is reliably able to make the user recognize the presentation information by a single presentation of the presentation information carried out by the selected electronic apparatus.

### Second Control Device and Third Control Device

The second information management unit 21a is a ROM, a RAM or the like, and stores and manages the holding information held by the home appliance 2. The second information management unit 21a transmits/receives various kinds of information to/from the first information management unit 11a via the second communication device 22. The second information management unit 21a may transmit/receive various kinds of information to/from the third information management units 31a and 41a to be described later via the second communication device 22. The third information management units 31a and 41a also have configuration and a function similar to those of the second information management unit 21a.

The second presentation management unit 21b manages the presentation information to be presented by the second presentation device 25. When the second presentation management unit 21b has received, from the server 1, presentation information to be presented to the user via the second communication device 22, the second presentation management unit 21b generates a presentation content from the contents of the presentation information in accordance with the presentation form by the second presentation device 25. The presentation content is, for example, an image to be displayed on the display unit included in the second presentation device 25, but the disclosure is not limited thereto; the presentation content may be any content in accordance with the type of the second presentation device 25. The third presentation management units 31b and 41b also have a function similar to that of the second presentation management unit 21b.

### Information Presentation Method by Information Presentation System

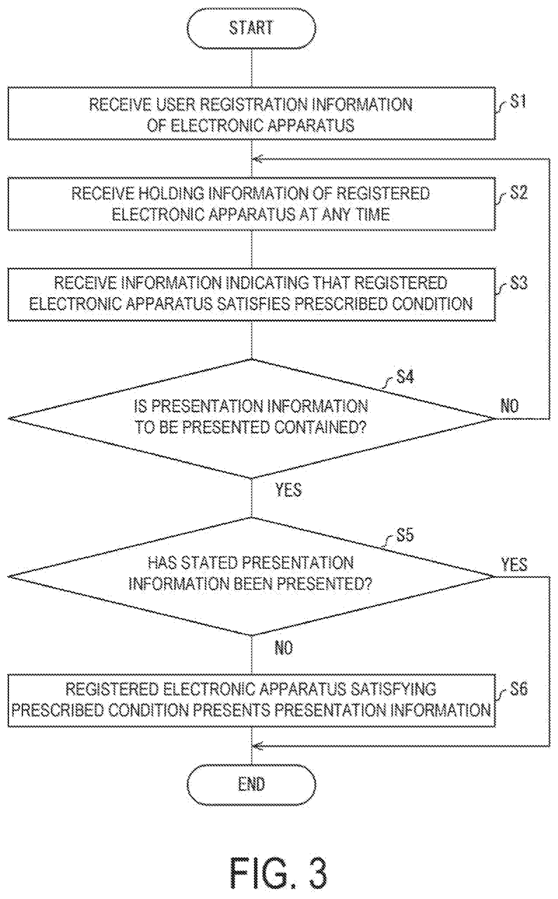

An information presentation method by the information presentation system 100 (a control method of the first control device 11) will be described below with reference to FIG. 3.

A user performs a user registration operation in advance to achieve a user registration in the server 1 for each of the electronic apparatuses owned by the user. For example, the user may perform the user registration operation through a user management application or the like provided in the first communication apparatus 3. In a case where the user attempts to achieve a user registration for an electronic apparatus owned by the user for the first time, the user needs to perform the user registration operation, for example, through the user management application or the like provided in the first communication apparatus 3.

In the case where there exists a registered electronic apparatus having achieved the user registration, the user is able to achieve a user registration for another electronic apparatus by using the above registered electronic apparatus. For example, the user may operate the user management application or the like from the first communication apparatus 3 having achieved the user registration and may physically operate the home appliance 2 almost at the same time, whereby the user registration for the home appliance 2 may be achieved. The physical operation is, for example, an operation of pressing a user registration button included in the home appliance 2.

With such configuration, the user is able to achieve a user registration only for the electronic apparatus that can be directly operated by the user. Accordingly, it is possible to prevent a situation in which a third party that is not a user of the electronic apparatus achieves a user registration without permission via a communication network for an electronic apparatus owned by another person.

When the user has carried out the user registration operation for an electronic apparatus, the first control device 11 receives user registration information from the registered electronic apparatus having achieved the user registration and stores the received information in the first information management unit 11a (S1). Next, at the time when holding information is transmitted from the registered electronic apparatus, or at the above-mentioned predetermined time interval, the presentation generation unit 11b receives the holding information of the registered electronic apparatus (S2).

Subsequently, when presentation preparation information indicating that the registered electronic apparatus satisfies a prescribed condition is received (S3), the presentation generation unit 11b determines whether the information to be presented to the user is contained in the holding information having been received in S2 (S4). When the information to be presented to the user is not contained in the holding information (NO in S4), the first control device 11 iterates and executes the processing of S2 to S4 until the information to be presented to the user is determined to be contained in the holding information.

When the information to be presented to the user is contained in the holding information (YES in S4), the presentation generation unit 11b generates presentation information from the holding information (presentation generation step). Then, the apparatus selection unit 11c determines whether the presentation information has been presented by any registered electronic apparatus (S5). The above determination is made based on the presence or absence of the presentation completion information described above. When it is determined that the presentation information has been presented (YES in S5), the apparatus selection unit 11c stops the selection of the selected electronic apparatus and terminates the sequence of processing. Accordingly, the presentation information is not presented by the selected electronic apparatus.

On the other hand, when it is determined that the presentation information has not been presented yet (NO in S5), the apparatus selection unit 11c selects the registered electronic apparatus having transmitted the presentation preparation information to the server 1 as a selected electronic apparatus, and causes the selected electronic apparatus to present the presentation information (S6; apparatus selection step).

### Modification

In the present embodiment, a case is described in which the information presentation system 100 includes registered electronic apparatuses each able to present presentation information by a highly reliable presentation form, and the apparatus selection unit 11c selects a selected electronic apparatus by using the presentation preparation information from the registered electronic apparatuses. However, as a modification of the present embodiment, the information presentation system 100 may only include registered electronic apparatuses each able to present the presentation information only by a not-highly reliable presentation form.

As discussed above, in the case where the registered electronic apparatuses included in the information presentation system 100 are only such registered electronic apparatuses that are able to present the presentation information only by the not-highly reliable presentation form, the apparatus selection unit 11c does not use the presentation preparation information for selecting a selected electronic apparatus. The apparatus selection unit 11c selects a predetermined number of selected electronic apparatuses from among the registered electronic apparatuses. The predetermined number may be one, or two or more, but is preferable to be less than the number of all registered electronic apparatuses included in the information presentation system 100. When the urgency level of the presentation information is low, no selected electronic apparatus may be selected.

According to such a configuration, even in a case where only the registered electronic apparatuses that are able to present the presentation information by not-highly reliable presentation forms are included in the information presentation system 100, the apparatus selection unit 11c is able to raise the probability of the presentation information being recognized by the user while preventing a situation in which a large amount of duplicate presentation information is presented to the user.

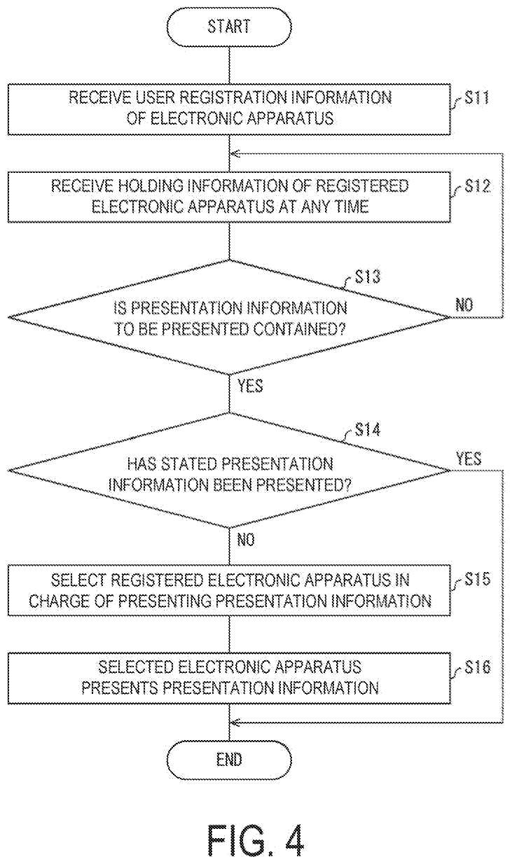

A method of information presentation by the information presentation system 100 according to the modification will be described below with reference to FIG. 4.

When a user has carried out a user registration operation for an electronic apparatus, the first control device 11 receives user registration information from the registered electronic apparatus having achieved the user registration and stores the received information in the first information management unit 11a (S11). The user registration operation is not described here because it is similar to the operation described above. Next, at the time when holding information is transmitted from the registered electronic apparatus, or at the above-mentioned predetermined time interval, the presentation generation unit 11b receives the holding information of the registered electronic apparatus (S12).

Subsequently, the presentation generation unit 11b determines whether the information to be presented to the user is contained in the holding information having been received in S12 (S13). When the information to be presented to the user is not contained in the holding information (NO in S13), the first control device 11 iterates and executes the processing or S12 to S13 until the information to be presented to the user is determined to be contained in the holding information.

When the information to be presented to the user is contained in the holding information (YES in S13), the presentation generation unit 11b generates presentation information from the holding information (presentation generation step).

Then, it is determined whether the presentation information has been presented by any registered electronic apparatus (S14). The apparatus selection unit 11c makes the determination in S14 based on the presence or absence of the presentation completion information. When it is determined that the presentation information has been presented (YES in S14), the apparatus selection unit 11c stops the selection of the selected electronic apparatus and terminates the sequence of processing. Accordingly, the presentation information is not presented by the selected electronic apparatus.

On the other hand, when it is determined that the presentation information has not been presented yet (NO in S14), the apparatus selection unit 11c selects the registered electronic apparatus in charge of presenting the presentation information as a selected electronic apparatus (S15; apparatus selection step). At this time, the apparatus selection unit 11c may select only one selected electronic apparatus, or may select two or more registered electronic apparatuses as selected electronic apparatuses. Then, the apparatus selection unit 11c causes the selected electronic apparatus to present the presentation information (S17).

### Implementation Example by Software

Control blocks of the first control device 11 (in particular, the presentation generation unit 11b and the apparatus selection unit 11c) may be implemented by logic circuit hardware) formed in integrated circuits (IC chips) and the like, or may be implemented by software.

In the latter case, the first control device provided with a computer configured to execute instructions of a program as software for enabling respective functions. The stated computer includes at least one processor (control device), for example, and includes at least one computer-readable recording medium having stored the program therein. In the computer, the processor reads out the program from the recording medium and executes the program, thereby accomplishing the object of the disclosure. For example, central processing unit (CPU) may be used as the processor. As the recording medium, a “non-transitory tangible medium” such as a tape, a disk, a card, a semiconductor memory, and a programmable logic circuit may be used in addition to a read only memory (ROM). Additionally, a random access memory (RAM) on which the program is loaded, or the like may be further provided. Further, the program may be supplied to the computer via any transmission medium (communication network, broadcast wave, or the like) capable of transmitting the program. Note that an aspect of the disclosure may be implemented in a form of data signal embedded in a carrier wave, which is embodied by electronic transmission of the program.

### Supplement

A control device (a first control device 11) according to a first aspect of the disclosure is a control device configured to control an information presentation system (100) constituted of a plurality of electronic apparatuses (a home appliance 2, a first communication apparatus 3, and a second communication apparatus 4) each having a communication function and a server (1) capable of performing transmission and/or reception with at least one of the plurality of electronic apparatuses. The control device includes: a presentation generation unit (11b) configured to execute presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received; and an apparatus selection unit (11c) configured to execute apparatus selection processing in which an electronic apparatus of the plurality of electronic apparatuses in charge of performing presentation of the presentation information is selected in accordance with information presentation forms of the plurality of electronic apparatuses.

The control device according to a second aspect of the disclosure is such that, in the first aspect, the presentation generation unit may receive presentation preparation information indicating that an electronic apparatus of the plurality of electronic apparatuses satisfies a prescribed condition to perform the presentation from the electronic apparatus, and the apparatus selection unit may select the electronic apparatus that has transmitted the presentation preparation information as the electronic apparatus in charge of performing presentation of the presentation information.

The control device according to a third aspect of the disclosure is such that, in the first or second aspect, the presentation generation unit may receive presentation completion information indicating that the presentation has been carried out by the electronic apparatus selected by the apparatus selection unit from the electronic apparatus that has carried out the presentation, and the apparatus selection unit may stop, in a case where the presentation generation unit receives the presentation completion information, the apparatus selection processing to cause the presentation information that has been presented to be presented.

The control device according to a fourth aspect of the disclosure is such that, in the first to third aspects, the holding information may include at least one of running information indicating a running state of each of the plurality of electronic apparatuses, storage information stored in advance in each of the plurality of electronic apparatuses, or detection information detected by a detection device provided in each of the plurality of electronic apparatuses.

A server (1) according to a fifth aspect of the disclosure is a server configured to communicate with a plurality of electronic apparatuses (a home appliance 2, a first communication apparatus 3, and a second communication apparatus 4) to constitute an information presentation system (100) and included in the plurality of electronic apparatuses. The server includes at least one control device (a first control device 11), and the at least one control device executes presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received, and also executes apparatus selection processing in which an electronic apparatus of the plurality of electronic apparatuses in charge of performing presentation of the presentation information is selected in accordance with information presentation forms of the plurality of electronic apparatuses.

An information presentation system (100) according to a sixth aspect of the disclosure is an information presentation system constituted of a plurality of electronic apparatuses (a home appliance 2, a first communication apparatus 3, and a second communication apparatus 4) each having a communication function and a server capable of performing transmission and/or reception with at least one of the plurality of electronic apparatuses, and controlled by at least one control device (a first control device 11). The at least one control device executes presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received, and also executes apparatus selection processing in which an electronic apparatus of the plurality of electronic apparatuses in charge of performing presentation of the presentation information is selected in accordance with information presentation forms of the plurality of electronic apparatuses.

A control method according to a seventh aspect of the disclosure is a control method for a control device (a first control device 11) configured to control an information presentation system (100) constituted of a plurality of electronic apparatuses (a home appliance 2, a first communication apparatus 3, and a second communication apparatus 4) each having a communication function and a server (1) capable of performing transmission and/or reception with at least one of the plurality of electronic apparatuses. The control method includes executing presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received; and executing apparatus selection processing in which an electronic apparatus of the plurality of electronic apparatuses in charge of performing presentation of the presentation information is selected in accordance with information presentation forms of the plurality of electronic apparatuses.

The control device according to each of the aspects of the disclosure may be implemented by a computer. In this case, a control program of the control device that causes the computer no function as each unit (software module) included in the control device to implement the control device by the computer, and a computer-readable recording medium having stored therein the control program fall within the scope of the disclosure.

### Supplementary Information

The disclosure is not limited to each of the above-described embodiments. It is possible to make various modifications within the scope of the claims. An embodiment obtained by appropriately combining technical elements each disclosed in different embodiments falls also within the technical scope of the disclosure. Furthermore, technical elements disclosed in the respective embodiments may be combined to provide a new technical feature.

While preferred embodiments of the present invention have been described above, it is to be understood that variations and modifications will be apparent no those skilled in the art without departing from the scope and spirit of the present invention. The scope of the present invention, therefore, is to be determined solely by the following claims.

1. A control device configured to control an information presentation system constituted of a plurality of electronic apparatuses each having a communication function and a server capable of performing transmission and/or reception with at least one of the plurality of electronic apparatuses, the control device comprising:
a presentation generation unit configured to execute presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received; and
an apparatus selection unit configured to execute apparatus selection processing in which an electronic apparatus of the plurality of electronic apparatuses in charge of performing presentation of the presentation information is selected in accordance with information presentation forms of the plurality of electronic apparatuses.

2. The control device according to claim 1,
wherein the presentation generation unit receives presentation preparation information indicating that an electronic apparatus of the plurality of electronic apparatuses satisfies a prescribed condition to perform the presentation from the electronic apparatus, and
the apparatus selection unit selects the electronic apparatus that has transmitted the presentation preparation information as the electronic apparatus in charge of performing presentation of the presentation information.

3. The control device according to claim 1,
wherein the presentation generation unit receives presentation completion information indicating that the presentation has been carried out, by the electronic apparatus selected by the apparatus selection unit from the electronic apparatus that has carried out the presentation, and
the apparatus selection unit stops, in a case where the presentation generation unit receives the presentation completion information, the apparatus selection processing to cause the presentation information that has been presented to be presented.

4. The control device according to claim 1,
wherein the holding information includes at least one of running information indicating a running state of each of the plurality of electronic apparatuses, storage information stored in advance in each of the plurality of electronic apparatuses, or detection information detected by a detection device included in each of the plurality of electronic apparatuses.

5. A server configured to communicate with a plurality of electronic apparatuses to constitute an information presentation system and included in the plurality of electronic apparatuses, the server comprising:
at least one control device,
wherein the at least one control device executes presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received, and also executes apparatus selection processing in which an electronic apparatus of the plurality of electronic apparatuses in charge of performing presentation of the presentation information is selected in accordance with information presentation forms of the plurality of electronic apparatuses.

6. An information presentation system constituted of a plurality of electronic apparatuses each having a communication function and a server capable of performing transmission and/or reception with at least one of the plurality of electronic apparatuses, and controlled by at least one control device,
wherein the at least one control device executes presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received, and also executes apparatus selection processing in which an electronic apparatus of the plurality of electronic apparatuses in charge of performing presentation of the presentation information is selected in accordance with information presentation forms of the plurality of electronic apparatuses.

7. A non-transitory computer readable medium recording a control program configured to cause a computer to function as the control device according to claim 1,
wherein the computer is caused to function as the presentation generation unit and the apparatus selection unit by the control program.

8. A control method for a control device configured to control an information presentation system constituted of a plurality of electronic apparatuses each having a communication function and a server capable of performing transmission and/or reception with at least one of the plurality of electronic apparatuses, the method comprising:
executing presentation generation processing in which, from at least one of the plurality of electronic apparatuses, holding information held by the at least one of the plurality of electronic apparatuses is received, and presentation information to be presented to a user of the plurality of electronic apparatuses is generated from contents of the holding information that is received; and
executing apparatus selection processing in which an electronic apparatus of the plurality of electronic apparatuses in charge of performing presentation of the presentation information is selected in accordance with information presentation forms of the plurality of electronic apparatuses.
